(19) United States
(12) Patent Application Publication
(10) Pub. No.: US 2006/0127842 A1
(43) Pub. Date: Jun. 15, 2006

(54) Integrated dental equipment

(76) Inventors: Randall Maxwell, Broken Arrow, OK (US); Charles E. Garrott, Tulsa, OK (US)

Correspondence Address: Douglas J. Hura, Esquire;DENTSPLY International Inc., 570 West College Avenue, P.O. Box 872, York, PA, 17405-0872, US

(21) Appl. No.: 11/012,995

(22) Filed: Dec. 15, 2004

(51) Int. Cl. A61C 1/02

(52) U.S. Cl. 433/101; 433/98

(57) ABSTRACT

An integrated dental system (10) includes a power connector base (11) having a plurality of electrical connectors (30) and a plurality of foot pedal connectors (31). A plurality of handpieces (12) are connected via their standard control units (20) to both the electrical connectors (30) and the foot pedal connectors (31). A single foot pedal (13) is employed to selectively operate and actuate each handpiece (12) as desired.

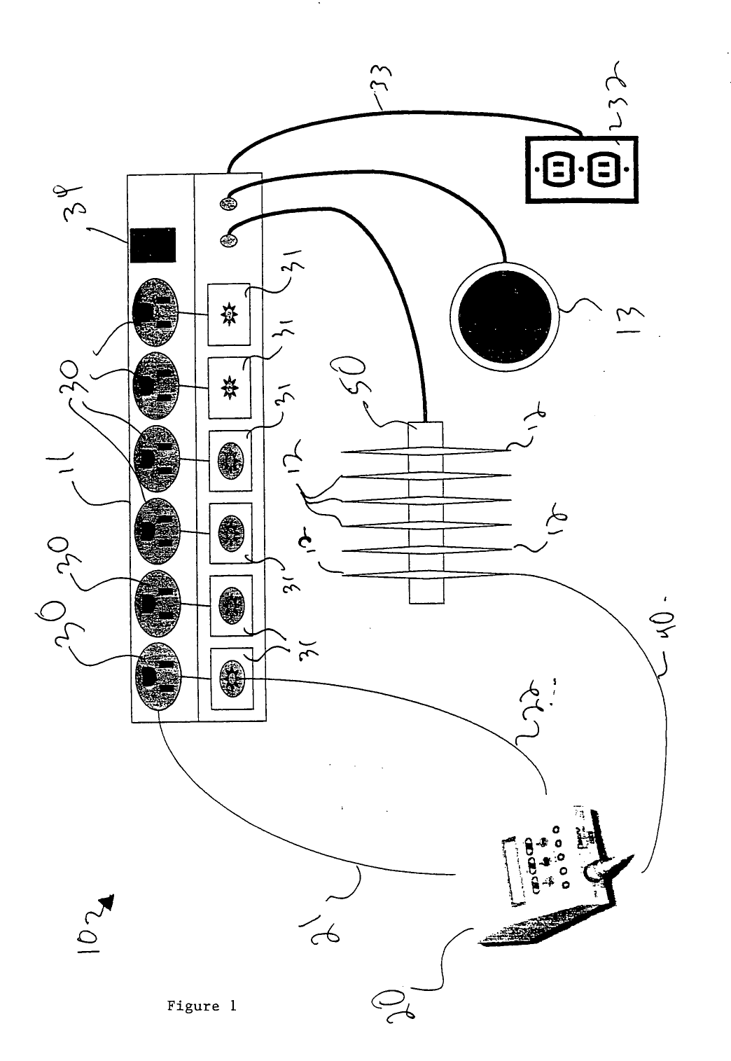

### TECHNICAL FIELD

The present invention is directed toward the integration of dental equipment. More particularly the invention provides for the operation of different dental equipment that makes use of single common components such as power supply, foot pedal controls and the like.

### BACKGROUND OF THE INVENTION

With advances in dental technology, dental offices have become cluttered with a large number of different instruments and pieces of equipment. Doctors are frustrated with multiple foot pedals and cords cluttering the operatory. Competition for counter space, or “footprint”, from various dental equipment items such as motors, ultrasonic units, obturation devices, apex locators, prophylaxis equipment, drills, handpieces and the like (all such equipment being generally referred to as handpieces herein) is an increasing problem in the industry. A growing interest in carts, integrated operatory equipment, and rolling product organizers has been the result.

A need exists therefore for a simple and efficient means to integrate a number of such items such that a common number of components may be employed, replacing multiple such components with a single, shared component.

### SUMMARY OF THE INVENTION

An integrated dental system therefore, includes for example, a common power source, a common actuating foot pedal, and common handpiece organizer or other common dental equipment organizer.

### BRIEF DESCRIPTION OF THE DRAWINGS

The drawing FIGURE shows a partially schematic view of an integrated dental equipment system according to the present invention.

### PREFERRED EMBODIMENT FOR CARRYING OUT THE INVENTION

In the drawing, an integrated dental equipment system according to the present invention is generally designated by the numeral 10. Integrated system 10 includes a power connector base unit 11, a plurality of handpieces 12, and an actuating foot pedal 13. The present invention is intended to provide a common power supply and foot pedal control for a plurality of handpieces 12. The exact nature of the handpieces 12 is not critical to the operation of the invention. Therefore, handpieces 12 can be any of those discussed above, or any similar equipment. Each dental handpiece 12 has a control unit 20, which is unique to that handpiece. As is common, each control unit 20 has an electrical connection 21 to an electrical power supply, and a foot pedal connection 22. It has been the practice prior to the present invention, that each control unit 20 was required to have its own electrical connection 21 to a separate power supply or outlet, and foot pedal cable connection 22 to a separate foot pedal (not shown).

According to the present invention, connector base 11 provides both electrical power and foot pedal connections for each of a plurality of control units 20 and handpieces 12. Therefore, connector base 11 includes a plurality of electrical outlets 30 and a preferably equal plurality of foot pedal connectors 31. As will be appreciated, electrical outlets 30 will be the standard electrical outlet employed in the general geographic area wherein the system 10 is employed. Preferably, each electrical outlet 30 is grounded. Therefore, connector 21 is a simple power cord from the control unit 20 plugged into the electrical outlet 30. Connector base 11 is in turn connected to a standard power supply or wall outlet 32. This connection through a power cord 33 supplies electrical power to the connector base 11. A universal on/off switch 34 is provided wherein electrical power to the entire connector base 11 can be turned on or off as desired.

Foot pedal connectors 31 are configured to be unique to a given foot pedal cable connection 22 of the individual control unit 20 for a given handpiece 12. Therefore, each of the connectors 31 will vary according to the equipment employed by the end user. This equipment will also vary according to the manufacturer supplying the handpiece 12 and its associated control unit 20.

Electrically connected to connector base 11 is a foot pedal 13. Foot pedal 13 is operatively and electrically connected through connector base 11 to each of the individual foot pedal connectors 31 such that actuating foot pedal 13 causes an individual handpiece 12 to be actuated. Further, each individual handpiece 12 is also controlled by its control unit 20 in its standard manner. A given handpiece 12 is connected to its control unit 20 by its standard control cord 40.

Therefore, in use, it will be understood that a control unit 20 has an electrical connection 21, which is connected or “plugged” into an electrical outlet 30 of the connector base 11. Further, a foot pedal cable connection 22 rather than being connected directly to an actuating foot pedal, is instead connected to a foot pedal connector 31 on the connector base 11. Foot pedal 13 is electrically and operatively connected through foot pedal connectors 31 to the control unit 20 such that the handpiece 12 may be actuated by foot pedal 13. It will be appreciated therefore, that a plurality of handpieces 12 each connected to its own control unit 20 and connected to connector base 11 as described, can each individually be operated or actuated by foot pedal 13. Common electrical power is supplied through connector base 11 from wall outlet 32.

A common cradle or organizer 50 may also be included. Cradle 50 may be a desk cradle, a cart, a hanging cradle connected to other equipment, or the like. Cradle 50 may include on/off components (not shown) such that when a handpiece 12 is removed from cradle 50 its control unit 20 is actuated such that foot pedal 13 can then be used to control handpiece 12.

Therefore, it is clear that an integrated dental system according to the present invention provides for a common power supply and a common actuating means such as a foot pedal to a plurality of otherwise standard dental handpieces 12. By “handpiece” it is understood to mean any of the various commonly employed dental equipment pieces standard in the dental industry. These include without limitation, those discussed herein above. The invention has been exemplified with reference to the attached drawings for illustrative purposes only. All of the various embodiments within the scope of the invention have not necessarily been discussed but will be evident to one of ordinary skill in the art. The scope of the invention shall be limited only by the claims as may be provided herein.

What is claimed is:

1. An integrated dental equipment system comprises a power connector base; said power connector base includes a plurality of electrical outlets and a plurality of foot pedal connectors; a foot pedal is operatively and electrically connected through said power connector strip and through said foot pedal connectors such that said foot pedal is in operative communication to a plurality of handpieces connected to said power connector strip.
